(19) United States
(12) Patent Application Publication
(10) Pub. No.: US 2010/0277452 A1
(43) Pub. Date: Nov. 4, 2010

(54) MOBILE DISPLAY CONTROL SYSTEM

(75) Inventor: Yosuke Muraki, Tokyo (JP)

Correspondence Address: LAW OFFICES OF MIKIO ISHIMARU, 333 W. EL CAMINO REAL, SUITE 330, SUNNYVALE, CA, 94087, US

(73) Assignees: SONY CORPORATION, Tokyo (JP); SONY ELECTRONICS INC., Park Ridge, NJ (US)

(21) Appl. No.: 12/786,278

(22) Filed: May 24, 2010

Related U.S. Application Data
(63) Continuation-in-part of application No. 11/678,505, filed on Feb. 23, 2007, now abandoned.

(51) Int. Cl. G09G 5/00

(52) U.S. Cl. 345/207

(57) ABSTRACT

A method for operation of a mobile display control system is provided including providing a sensor for monitoring an ambient light level; modifying an unprocessed video stream based on the ambient light level from the sensor for forming a video stream; generating a pixel brightness and a contrast from the video stream and the ambient light level; creating a gamma corrected stream from the pixel brightness, the contrast, and the video stream; adjusting a display for viewing a video in the ambient light level by coupling the gamma corrected stream to the display; and adjusting the display for viewing a video at a set brightness for a set time where the ambient light level is changing.

### CROSS-REFERENCE TO RELATED APPLICATION

This is continuation-in-part of co-pending U.S. patent application Ser. No. 11/678,505 filed Feb. 23, 2007.

### TECHNICAL FIELD

The present invention relates generally to mobile display control, and more particularly to a system for controlling display characteristics in mobile devices.

### BACKGROUND ART

As the information age evolves to the personal communication age, many of the functions that were locked in the office have been liberated to travel with us around the clock. As an example, cell phones can deliver streaming video of our favorite movies or television shows. Portable computers can fit in a shirt pocket or sit in a dock on our desktop. In all of the applications that supply information and access to information a display is the visual link for delivery. In most of today's mobile devices, the display of choice is a liquid crystal display (LCD). In order to maintain a useful level of visibility the controls for adjusting the attributes of the display, such as brightness and contrast, need constant adjustment.

There are many approaches that are used to manage the attributes of an LCD today, but all of them leave something to be desired. Some are best tuned for bright sunlight and may be completely unusable in a dark environment. Other devices may have the opposite problem. It is obvious that the requirements of a mobile display device carried by a user are completely different from the display device of a stationary computer, such as a desk top computer. The desk top computer is maintained at the same location, therefore the environment in which it is used very rarely, if ever, changes. In a mobile electronic device, the environment of use is constantly changing and requires a more versatile display that is viewable in many different environments.

The convergence of the digital world has aided the progression by including a camera in almost every electronic communication device available today. The camera function evaluates the lighting conditions available for the current picture and adjusts the lens system appropriately to capture the photo. Many applications have attempted to use the camera to aid in control of the display. By adding software to utilize the camera, some rudimentary control of brightness has been possible, but unlike the camera no lens aperture or flash are available to adjust for the environment. To date, none of the applications has been fully successful. Every attempt to adjust the attributes of the mobile display has delivered some undesirable result such as no brightness in very dark environments or no contrast in bright environments.

Thus, a need still remains for a mobile display control system that provides a useful auto-adjustment of the display attributes in both light and dark environments. In view of the increasing demand for mobile communication devices that satisfy the user requirements for operation in all environmental conditions, it is increasingly critical that answers be found to these problems. In view of the ever-increasing commercial competitive pressures, along with growing consumer expectations and the diminishing opportunities for meaningful product differentiation in the marketplace, it is critical that answers be found for these problems. Additionally, the need to save costs, improve efficiencies and performance, and meet competitive pressures, adds an even greater urgency to the critical necessity for finding answers to these problems.

Solutions to these problems have been long sought but prior developments have not taught or suggested any solutions and, thus, solutions to these problems have long eluded those skilled in the art.

### DISCLOSURE OF THE INVENTION

The present invention provides a method for operation of a mobile display control system including: providing a sensor for monitoring an ambient light level; modifying an unprocessed video stream based on the ambient light level from the sensor for forming a video stream; generating a pixel brightness and a contrast from the video stream and the ambient light level; creating a gamma corrected stream from the pixel brightness, the contrast, and the video stream; adjusting a display for viewing a video in the ambient light level by coupling the gamma corrected stream to the display; and adjusting the display for viewing a video at a set brightness for a set time where the ambient light level is changing.

The present invention provides a mobile display control system that includes: a sensor for determining an ambient light level; a video source; a controller coupled to the sensor and the video source; a brightness and contrast manager coupled to the controller; a gamma correction block coupled to the controller and the brightness and contrast manager; and a display coupled to the gamma correction block for viewing a video at a set brightness for a set time where the ambient light level is changing.

Certain embodiments of the invention have other aspects in addition to or in place of those mentioned above. The aspects will become apparent to those skilled in the art from a reading of the following detailed description when taken with reference to the accompanying drawings.

### BRIEF DESCRIPTION OF THE DRAWINGS

FIG. 1 is a block diagram of a mobile display control system in an embodiment of the present invention.

FIG. 2 is a graph of the luminance response of the mobile display control system in an electronic device.

FIG. 3 is a diagram of an electronic device having the mobile display control system in a subdued light environment.

FIG. 4 is a graph of brightness regions of the mobile display control system.

FIG. 5 is a graph of contrast regions of the mobile display control system.

FIG. 6 is a block diagram of a mobile display control system in an alternative embodiment of the present invention.

FIG. 7 is a block diagram of a display module.

FIG. 8 is a time versus voltage diagram of the display of FIG. 1 or the backlight of FIG. 7 showing changes when a user moves from a dark place to a bright place.

FIG. 9 is a time versus voltage diagram of the display of FIG. 1 or the backlight of FIG. 7 showing changes when a user moves from a dark place to a bright place.

FIG. 10 is a time versus voltage diagram showing of the display of FIG. 1 or the backlight of FIG. 7 changes when a user moves from a bright place to a dark place and back very quickly.

FIG. 11 is a flow chart of a mobile display control system for operating the mobile display control system in an embodiment of the present invention.

### BEST MODE FOR CARRYING OUT THE INVENTION

The following embodiments are described in sufficient detail to enable those skilled in the art to make and use the invention. It is to be understood that other embodiments would be evident based on the present disclosure, and that process or mechanical changes may be made without departing from the scope of the present invention.

In the following description, numerous specific details are given to provide a thorough understanding of the invention. However, it will be apparent that the invention may be practiced without these specific details. In order to avoid obscuring the present invention, some well-known circuits, system configurations, and process steps are not disclosed in detail. Likewise, the drawings showing embodiments of the system are semi-diagrammatic and not to scale and, particularly, some of the dimensions are for the clarity of presentation and are shown greatly exaggerated in the drawing FIGs. Where multiple embodiments are disclosed and described, having some features in common, for clarity and ease of illustration, description, and comprehension thereof, similar and like features one to another will ordinarily be described with like reference numerals.

For expository purposes, the term “on” means there is direct contact among elements. The term “system” as used herein means and refers to the method and to the apparatus of the present invention in accordance with the context in which the term is used.

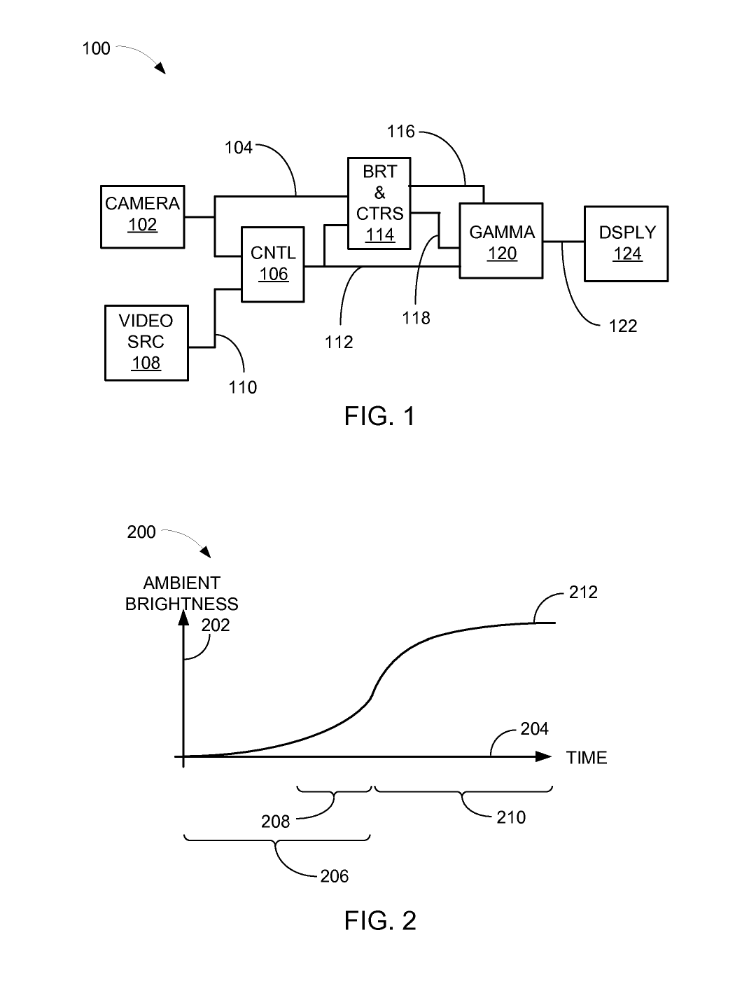

Referring now to FIG. 1, therein is shown a block diagram of a mobile display control system 100 in an embodiment of the present invention. The block diagram of the mobile display control system 100 depicts a sensor or camera 102, for monitoring the ambient light around the display, provides an ambient light level 104 coupled to a controller 106, such as a micro-controller, microprocessor, or graphics processing unit. A video source 108, such as a wireless antenna, a cellular telephone, or memory adapter, which supplies an unprocessed video stream 110, is also coupled to the controller 106 which supplies a video stream 112 for additional processing. The ambient light level 104 from the camera 102 is also coupled to a brightness and contrast manager 114 to supply ambient light information to the video stream 112 from the controller 106.

The pixel brightness and contrast manager 114 adjusts a pixel brightness 116 and a contrast 118 to be compatible with the ambient light level 104 detected by the camera 102. The pixel brightness 116, the contrast 118, and the video stream 112 are inputs to a gamma correction block 120, such as a dynamic gamma correction. A gamma corrected stream 122 is coupled to a display 124, such as a liquid crystal display, light emitting diode, or other video display. The gamma corrected stream 122 enables a video on the display 124 to ensure videos are not too dark, overly bright, or washed out regardless of the video format or manufacturer of the display 124.

The controller 106 may make the first level of adjustment to the unprocessed video stream 110 based on the ambient light level 104 provided by the camera 102 and the content of the unprocessed video stream 110. This first adjustment may result in the video stream 112 having a different luminosity than the unprocessed video stream 110. This adjustment may be either higher, lower, or no change depending on the circumstance. The first adjustment performed by the controller 106 is a gross signal adjustment that may allow the finer adjustments of the brightness and contrast manager 114 and the gamma correction block 120. It has been discovered that a distributed approach of adjusting the unprocessed video stream 110 to form the video stream 112, and further adjusting the video stream 112 to form the gamma corrected stream 122 provides effective and high quality video in any ambient light environment.

Referring now to FIG. 2, therein is shown a graph of a luminance response 200 of the mobile display control system 100 in an embodiment of the present invention. The graph of the luminance response 200 of the mobile display control system 100 depicts an ambient brightness 202 on the Y-axis, with the absolute value of the ambient brightness 202 increasing. The ambient brightness 202 is the amount of light in the environment around the user as the user moves from a dim light to a bright light. Time 204 is on the X-axis. Since no manufacturer to date has produced a perfect version of the display 124 of FIG. 1, there are operational limits to proper operation. A luminance range 206 reflects the inability to guarantee luminance output levels at the lower values of the ambient brightness 202.

A low intensity range 208 represents the range of luminance control for subdued light environments. A high intensity range 210 represents the range of luminance for medium to bright environments. A luminance “S” curve 212 may be characteristic of the display 124, such as a liquid crystal display. This idealized version shows the luminance “S” curve 212 as continuous curve down to the origin. It has been discovered that the low intensity range 208 may be accurately extended closer to the origin, by maintaining a minimum transparency of the display 124 and modulating the duration that the backlight (not shown) is turned on. This technique may provide a more accurate video picture in subdued light environments.

By alternating the polarity of the ambient brightness 202 on successive frames, the display 124 may be maintained in a neutral state. The neutral state of the ambient brightness 202 helps maintain the transition speed of the display 124.

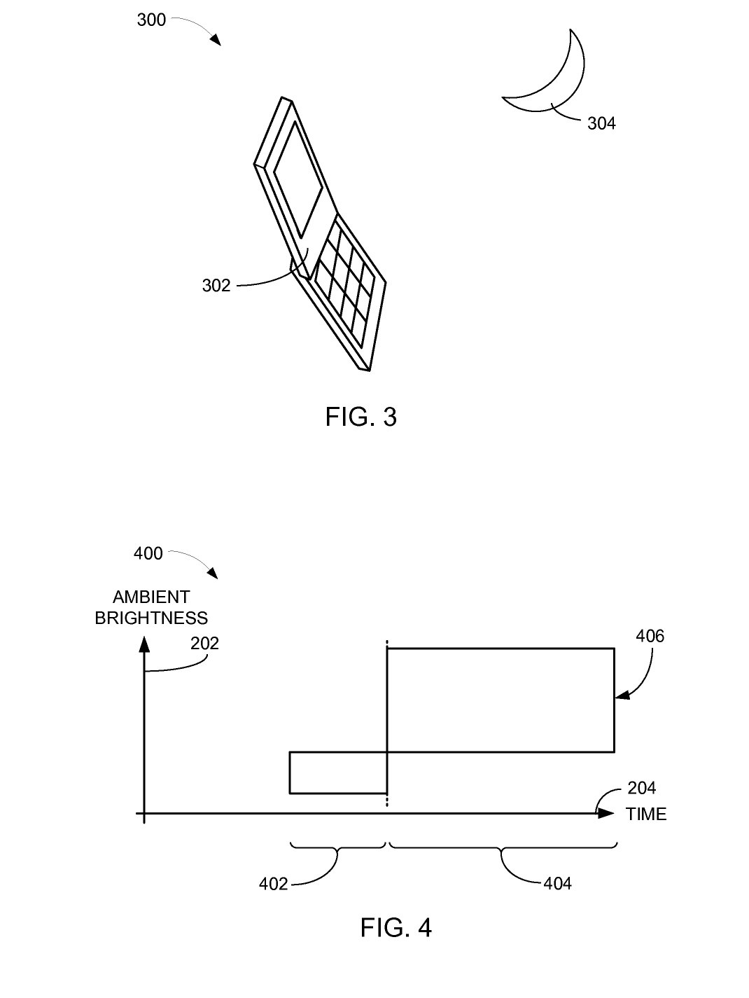

Referring now to FIG. 3, therein is shown a diagram of an electronic device 302 having the mobile display control system 100 in a subdued light environment. The diagram of the electronic device 302, such as a cell phone, personal data assistant, personal video player, or personal game console, may be adjusted to present a clear and crisp video display. The electronic device 302 is shown with an ambient light 304, such as “moon light” for example only. The mobile display control system 100 may be operated in any lighting environment including full sun light or the absence of the ambient light 304.

Referring now to FIG. 4, therein is shown a graph of brightness regions 400 of the mobile display control system 100. The graph of the brightness regions 400 depicts the ambient brightness 202 on the Y-axis, with the absolute value of the ambient brightness 202 increasing. Time 204 is on the X-axis. A subdued light region 402 and a bright light region 404 represent the range of possible adjustments based on the ambient light 304 of FIG. 3.

In the bright light region 404, the mobile display control system 100 of FIG. 1, increases the brightness of the display 124 of FIG. 1. The increase in brightness of the ambient light 304 requires that a brightness level 406 be increased to provide a clearly visible video on the display 124. In the subdued light region 402, too much brightness can wash out colors and result in blur. In order to balance the display 124, the brightness level 406 may be reduced. As shown in the graph of FIG. 4, there is less adjustment range available in the subdued light region 402. In order to fully exercise the adjustment options, a combination of controls must work together.

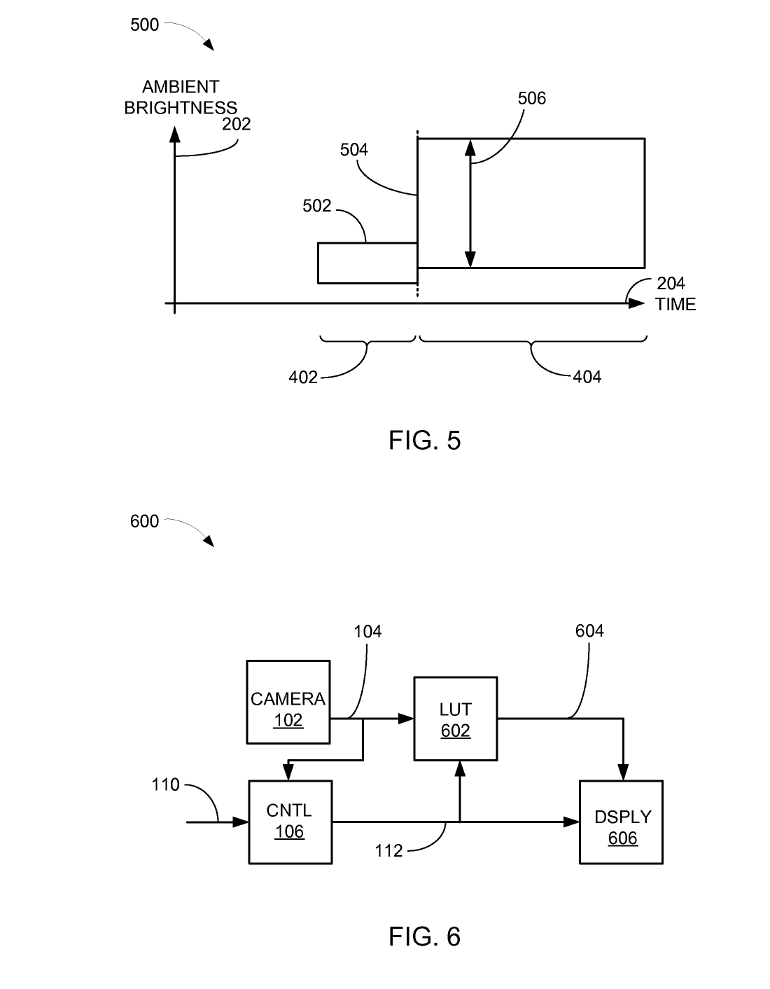

Referring now to FIG. 5, therein is shown a graph of contrast regions 500 of the mobile display control system 100. The graph of the contrast regions 500 depicts the ambient brightness 202 on the Y-axis, with the absolute value of the ambient brightness 202 increasing. Time 204 is on the X-axis. A contrast 502 is the ratio of the brightness of the lightest colors to the brightness of the darkest colors in the display 124 of FIG. 1. In the subdued light region 402, of FIG. 4, managing the contrast 502 presents a challenge, because the contrast 502 must remain between a peak brightness level 504 for that region and a minimum display level 506 below which colors cannot be discerned.

Where the display 124 is a liquid crystal display and a backlight is used, the transmissivity of the display 124 must be reduced to the minimum display level 506 while the backlight is at full intensity. However, it has been discovered that it is possible to increase the ambient brightness 202, which increases the transmissivity of the display 124, but the backlight can be modulated to reduce the overall brightness. This technique requires careful characterization of the backlight to operate correctly, but it is highly effective in reducing the time 204 for operation in the subdued light region 402.

Referring now to FIG. 6, therein is shown a block diagram of a mobile display control system 600 in an alternative embodiment of the present invention. The block diagram of the mobile display control system 600 depicts the camera 102 of FIG. 1 coupled to the controller 106 of FIG. 1. The controller 106 receives the unprocessed video stream 110 of FIG. 1 and with the ambient light level 104 of FIG. 1, produces the video stream 112 of FIG. 1. Both the video stream 112 and the ambient light level 104 are coupled to a look up table (LUT) 602, such as a matrix of values for the time 204 of FIG. 2, and the contrast 502 of FIG. 5. The look up table 602 may be a flash memory that generates control lines 604 that manage the time 204 and the contrast 502. The matrix of values in the look up table 602 includes a gamma correction of the time 204 and the contrast 502 that is matched to the display 124 of FIG. 1.

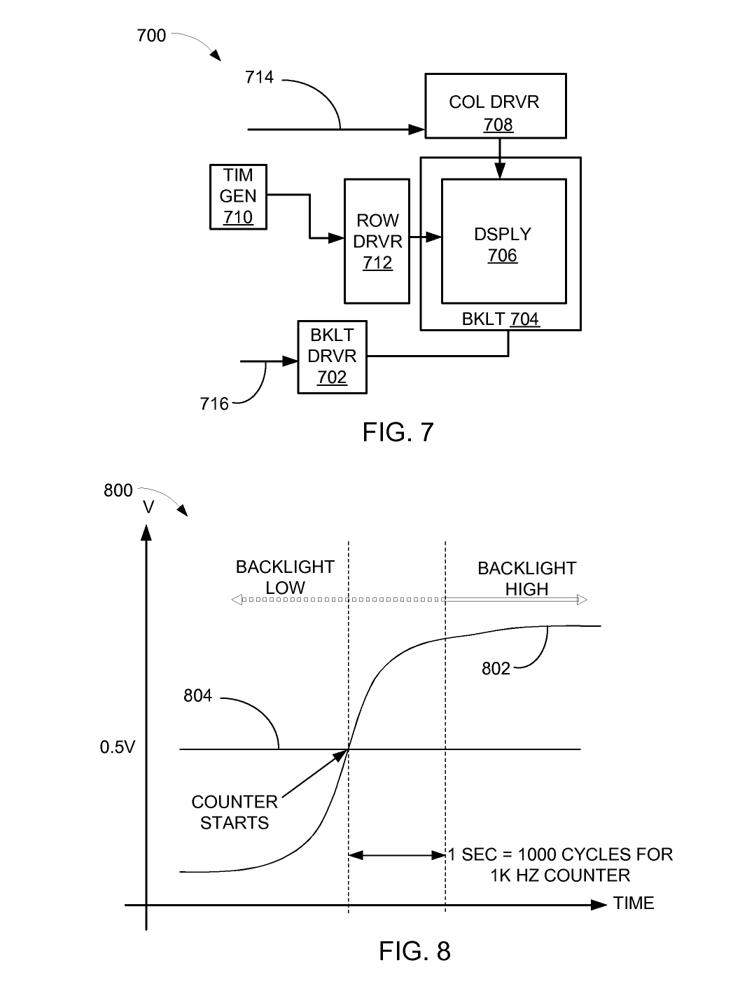

Referring now to FIG. 7, therein is shown a block diagram of a display module 700. The block diagram of the display module 700 depicts a backlight driver 702 coupled to a backlight 704, such as a cold cathode fluorescent lamp or a light emitting diode array, having a display panel 706 mounted thereon. A column driver 708 accesses the column of pixels (not shown) that make up the display panel 706. A timing generator 710 is coupled to a row driver 712 for selecting which row within the display panel 706 is currently addressed. A video 714 is applied to the column driver 708 to be shown on the display panel 706.

A brightness control 716 is an input to the backlight driver 702. The brightness control 716 may cause to the backlight 704 to remain on 100% of the time at full voltage for the brightest version of the video 714. The backlight driver 702 may have the option of reducing the voltage to the backlight 704 in order to dim the video 714. If a further dimming is required, the backlight driver 702 may perform pulse width modulation on the voltage driving the backlight 704. The pulse width modulation introduces a periodic off time in the voltage going to the backlight 704. This process may further reduce the brightness of the backlight 704.

Referring now to FIG. 8, therein is shown a time versus voltage diagram 800 of the display 124 of FIG. 1 or the backlight 704 of FIG. 7 showing changes when a user moves from a dark place to a bright place. Ambient light is converted to a voltage in the camera 102 of FIG. 1. Once light intensity 802, which is the ambient light converted to a voltage, gets above a threshold 804, a counter in the controller 106 of FIG. 1 starts to count and the display 124 or the backlight 704 does not change. When the counter reaches a predetermined count, the controller 106 brings the display 124 or the backlight 704 to high power.

For example, the threshold voltage, adjustable by the user, could be 0.5 volt and the predetermined count could be 1000 for a 1 k Hz counter, which equals to 1 second of time. This allows adjusting a display for viewing a video at a set brightness for a set time, such as the 1 second, where the ambient light level is increasing.

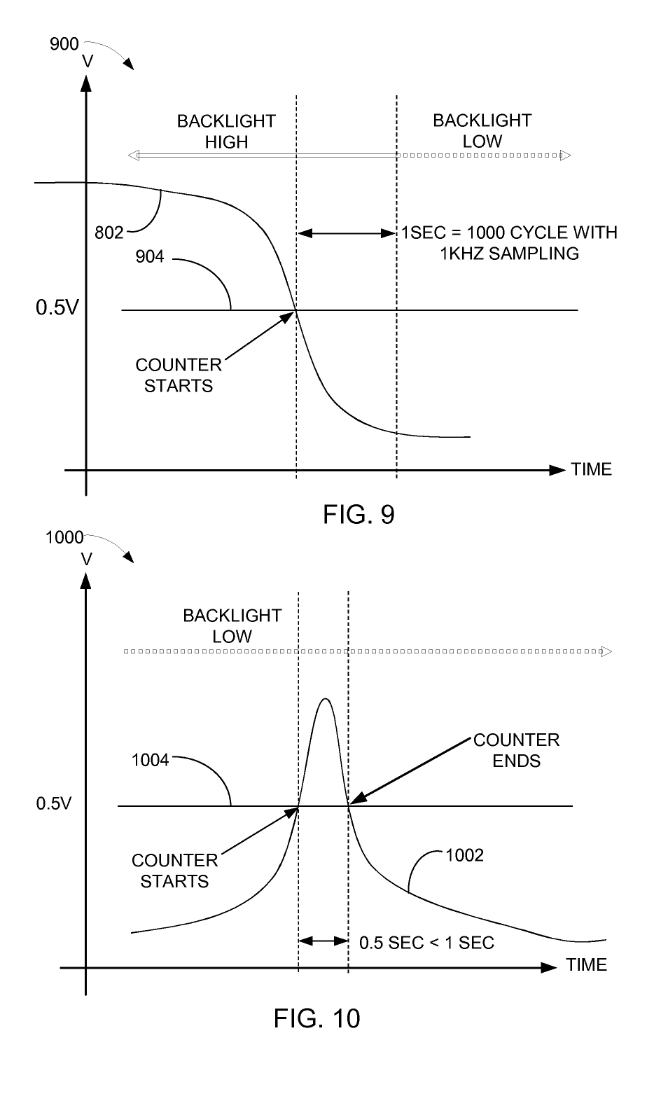

Referring now to FIG. 9, therein is shown a time versus voltage diagram 900 of the display 124 of FIG. 1 or the backlight 704 of FIG. 7 showing changes when a user moves from a bright place to a dark place. Once light intensity 802, which is converted to a voltage, drops below a threshold 904, a counter in the controller 106 of FIG. 1 starts to count and the display 124 or the backlight 704 does not change. When the counter reaches a predetermined count, the controller 106 dims the display 124 or the backlight 704 to low power.

For example, the threshold voltage could be 0.5 volt and the predetermined count could be 1000 for a 1 k Hz counter, which equals to 1 second of time. Different voltages and counts can be used going from bright to dark and vice versa based on how the human eye responds to changes in light. This allows adjusting a display for viewing a video at a set brightness for a set time where the ambient light level is decreasing.

Referring now to FIG. 10, therein is shown a time versus voltage diagram 1000 of the display 124 of FIG. 1 or the backlight 704 of FIG. 7 showing changes when a user moves from a dark place to a bright place and back very quickly. Once light intensity 1002, which is converted the ambient light converted to a voltage, gets above a threshold 1004, a counter in the controller 106 of FIG. 1 starts to count. If the ambient light changes quickly, the count ends and the display 124 or the backlight 704 does not change. The light intensity 1002 would be inverted when a user moves from a bright place to a dark place and back quickly. For the display 124 or the backlight 704 to change, the count must be restarted and maintained to the full count. This allows adjusting a display for viewing a video at a set brightness for a set time where the ambient light level fluctuates rapidly. This arrangement prevents blinking ambient light from causing the display 124 or the backlight 704 from flickering.

In FIGS. 8-10, all of the time values on the x-axis are an average of a certain amount of time, such as 500 μs. So, if sampling frequency of an A/D converter used in counting is 1 MHz, the digital value is accumulated or averaged to a 1 k Hz value.

Also, with regard to FIGS. 8-10, it should be noted that the light intensities reaching the thresholds is determined using voltages and a voltage comparator in the controller 106 of FIG. 1. The light intensity voltages and threshold voltages can just as easily be converted to digital signals using an analog to digital converter in the controller 106 and the digital signals compared in the controller 106.

Still further regarding FIGS. 8-10, more than one threshold and different display or backlight brightnesses can be used to provide greater versatility.

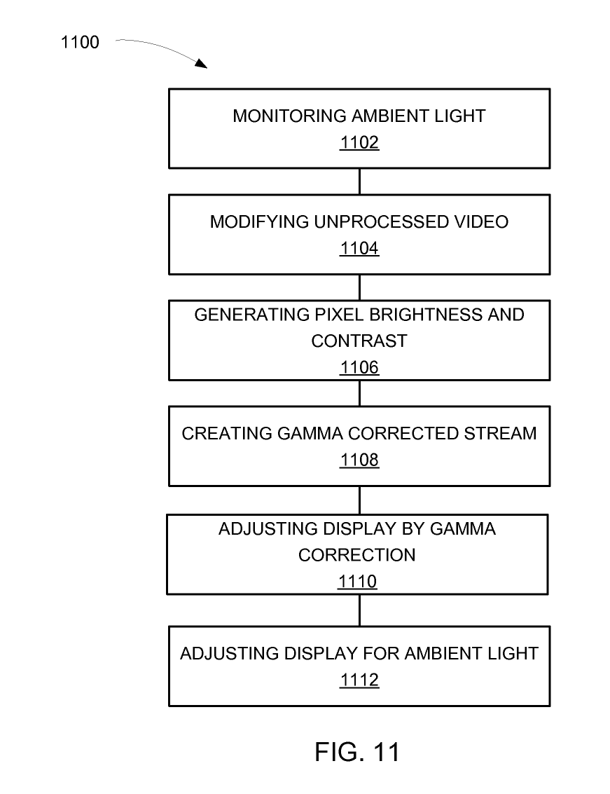

Referring now to FIG. 11, therein is shown a flow chart of a mobile display control system 1100 for operating the mobile display control system 100 in an embodiment of the present invention. The system 1100 includes providing a camera for monitoring an ambient light level in a block 1102; modifying an unprocessed video stream based on the ambient light level from the camera for forming a video stream in a block 1104; generating a pixel brightness and a contrast from the video stream and the ambient light level in a block 1106; creating a gamma corrected stream from the pixel brightness, the contrast, and the video stream in a block 1108; adjusting a display for viewing a video in the ambient light level by coupling the gamma corrected stream to the display in a block 1110; and adjusting the display for viewing a video at a set brightness for a set time in a changing ambient light level in a block 1112.

In greater detail, a system to operate a mobile display control system, according to an embodiment of the present invention, is performed as follows:
1. Providing a camera for monitoring an ambient light level including determining a subdued light region;
2. Modifying an unprocessed video stream based on the ambient light level from the camera for forming a video stream including adjusting the video stream to the ambient light level;
3. Generating a pixel brightness and a contrast from the video stream and the ambient light level including adjusting the pixel brightness for maintaining the contrast of the video stream);
4. Creating a gamma corrected stream from the pixel brightness, the contrast and the video stream including adjusting the pixel brightness and the contrast including a video having no saturated colors or blurring;
5. Adjusting a display for viewing a video in the ambient light level by coupling the gamma corrected stream to the display; and
6. Adjusting the display for viewing a video in the ambient light level.

Thus, it has been discovered that the mobile display control system of the present invention furnishes important and heretofore unknown and unavailable solutions, capabilities, and functional aspects for mobile display control systems. The resulting processes and configurations are straightforward, cost-effective, uncomplicated, highly versatile and effective, can be surprisingly and non-obviously implemented by adapting known technologies, and are thus readily suited for efficiently and economically manufacturing mobile electronic devices having a display control system, fully compatible with conventional manufacturing processes and technologies. While the invention has been described in conjunction with a specific best mode, it is to be understood that many alternatives, modifications, and variations will be apparent to those skilled in the art in light of the aforegoing description. Accordingly, it is intended to embrace all such alternatives, modifications, and variations that fall within the scope of the included claims. All matters hithertofore set forth herein or shown in the accompanying drawings are to be interpreted in an illustrative and non-limiting sense.

What is claimed is:

1. A method for operation of a mobile display control system comprising:
providing a sensor for monitoring an ambient light level;
modifying an unprocessed video stream based on the ambient light level from the sensor for forming a video stream;
generating a pixel brightness and a contrast from the video stream and the ambient light level;
creating a gamma corrected stream from the pixel brightness, the contrast, and the video stream;
adjusting a display for viewing a video in the ambient light level by coupling the gamma corrected stream to the display; and
adjusting the display for viewing a video at a set brightness for a set time where the ambient light level is changing.

2. The method as claimed in claim 1 wherein adjusting the display including modulating a backlight for modulating the pixel brightness.

3. The method as claimed in claim 1 wherein generating the pixel brightness and the contrast includes:
generating a look up table for providing the pixel brightness and the contrast for displaying the video; and
accessing the look up table based on the ambient light level and the video stream.

4. The method as claimed in claim 1 wherein forming the video stream includes:
accessing the ambient light level; and
adjusting the pixel brightness of the unprocessed video stream based on the ambient light level.

5. The method as claimed in claim 1 further comprising increasing a pixel brightness and dimming a backlight for displaying a video in a subdued light region.

6. A method for operation of a mobile display control system comprising:
providing a sensor for monitoring an ambient light level including determining a subdued light region;
modifying an unprocessed video stream based on the ambient light level from the sensor for forming a video stream including adjusting the video stream to the ambient light level;
generating a pixel brightness and a contrast from the video stream and the ambient light level including adjusting the pixel brightness for maintaining the contrast of the video stream;
creating a gamma corrected stream from the pixel brightness, the contrast and the video stream including adjusting the pixel brightness and the contrast including a video having no saturated colors or blurring;
adjusting a display for viewing a video in the ambient light level by coupling the gamma corrected stream to the display; and
adjusting the display for viewing a video at a set brightness for a set time where the ambient light level is changing.

7. The method as claimed in claim 6 wherein adjusting the display including modulating a backlight for modulating the pixel brightness including driving the backlight with a changed voltage, a changed frequency or a combination thereof.

8. The method as claimed in claim 6 wherein generating the pixel brightness and the contrast includes:
generating a look up table for providing the pixel brightness and the contrast for displaying the video including providing a matrix of values for the pixel brightness and the contrast; and
accessing the look up table based on the ambient light level and the video stream including delivering a brightness control to a backlight driver.

9. The method as claimed in claim 6 wherein forming the video stream includes:
accessing the ambient light level including determining the subdued light region; and
adjusting the pixel brightness of the unprocessed video stream by the controller based on the ambient light level.

10. The method as claimed in claim 6 further comprising increasing a pixel brightness and dimming a backlight for displaying a video in a subdued light region including applying a brightness control for dimming the backlight.

11. A mobile display control system comprising:
a sensor for determining an ambient light level;
a video source;
a controller coupled to the sensor and the video source;
a brightness and contrast manager coupled to the controller;
a gamma correction block coupled to the controller and the brightness and contrast manager; and
a display coupled to the gamma correction block for viewing a video at a set brightness for a set time where the ambient light level is changing.

12. The system as claimed in claim 11 further comprising:
a backlight; and
a backlight driver coupled to the backlight for modulating the pixel brightness.

13. The system as claimed in claim 11 wherein the video source includes a memory adapter.

14. The system as claimed in claim 11 further comprising a look up table coupled to the controller.

15. The system as claimed in claim 11 further comprising:
a backlight; and
a display panel on the backlight for displaying the video.

16. The system as claimed in claim 11 further comprising a brightness line coupled to the gamma correction block.

17. The system as claimed in claim 16 further comprising:
a backlight includes a cold cathode fluorescent lamp; and
a backlight driver coupled to the backlight for modulating the pixel brightness includes a pulse width modulation applied to the backlight.

18. The system as claimed in claim 16 wherein the video source includes a wireless antenna, a cellular telephone, or a memory adapter.

19. The system as claimed in claim 16 further comprising a look up table coupled to the controller includes a flash memory coupled to the controller.

20. The system as claimed in claim 16 further comprising:
a backlight includes a light emitting diode array; and
a display panel on the backlight for displaying the video includes column drivers and row drivers to address pixels.
